(19) United States
(12) Patent Application Publication
(10) Pub. No.: US 2024/0399522 A1
(43) Pub. Date: Dec. 5, 2024

(54) TOOL HOLDER WITH ENHANCED COOLING EFFECT

(71) Applicant: SHIN-YAIN INDUSTRIAL CO., LTD., Taichung City (TW)

(72) Inventor: PEN HUNG CHEN, Taichung City (TW)

(21) Appl. No.: 18/327,461

(22) Filed: Jun. 1, 2023

(51) Int. Cl. B23Q 11/10

(52) U.S. Cl. CPC B23Q 11/1023

(57) ABSTRACT

A tool holder has a body and multiple flow passage systems. A tool connecting portion of the body has a coolant entering groove, a connecting groove, an annular ditch, and an annular inclined surface. The annular ditch is formed inside the connecting groove and near the opening. The annular inclined surface is connected to a side of the annular ditch facing the opening, and an included angle is between the annular inclined surface and an axis of the body such that the annular inclined surface tapers away from the opening. The flow passage systems are disposed on the body and communicate with the coolant entering groove such that coolant can be ejected toward a tool mounted on the tool holder and can flow to the annular ditch to further cool the tool and flow out of the body from the divergent annular inclined surface.

### BACKGROUND OF THE INVENTION

### 1. Field of the Invention

The present invention relates to a tool holder, and particularly to a tool holder with enhanced cooling effect that allows coolant to be ejected.

### 2. Description of Related Art

A conventional tool holder with coolant outlets has a body and multiple flow passages. The body has a tool connecting portion, and the tool connecting portion has a coolant entering groove and a connecting groove communicating with each other. The connecting groove is configured for connecting a tool. The multiple flow passages are formed on the tool connecting portion at spaced intervals, and each one of the multiple flow passages has an inlet section communicating with the coolant entering groove and an outlet section communicating with the inlet section. The outlet section extends to and through a front end of the tool connecting portion such that coolant can flow from the coolant entering groove inside the body, flow through the inlet section and the outlet section of each one of the multiple flow passages, and be ejected toward a front end of the tool (i.e. the portion for cutting) to cool and lubricate the tool when manufacturing.

However, the conventional tool holder with coolant outlets only cools the portion for cutting on the tool, and another portion on the tool covered by the body may still be heated and have a thermal displacement, which causes machining errors.

To overcome the shortcomings of the conventional tool holder with coolant outlets, the present invention tends to provide a tool holder with enhanced cooling effect to mitigate or obviate the aforementioned problems.

### SUMMARY OF THE INVENTION

The main objective of the present invention is to provide a tool holder with enhanced cooling effect that may enhance effect of cooling a tool mounted on the tool holder by configuration of flow passages.

The tool holder with enhanced cooling effect has a body and multiple flow passage systems. The body has a tool connecting portion having two opposite ends, a coolant entering groove, a connecting groove, an annular ditch, and an annular inclined surface. The two opposite ends of the body are respectively a front end and a rear end. The connecting groove is coaxially formed at a center of the tool connecting portion and has an opening located near the front end. The annular ditch is formed on an inside wall of the connecting groove and near the opening. The annular inclined surface is connected to a side of the annular ditch facing the opening. The body has an included angle defined between the annular inclined surface and an axis of the body such that the annular inclined surface tapers away from the opening. The multiple flow passage systems are formed on the body at spaced intervals, and each one of the multiple flow passage systems has an inlet passage, a main passage, and a branch passage. The inlet passage is disposed on the tool connecting portion and communicates with the coolant entering groove. The main passage extends from the inlet passage and through the front end of the tool connecting portion. The branch passage extends obliquely from the main passage to the annular ditch and communicates with the annular ditch.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of a tool holder with enhanced cooling effect in accordance with the present invention;

FIG. 2 is a partial sectional view of the tool holder in FIG. 1;

FIG. 3 is a front side view of the tool holder in FIG. 1;

FIG. 4 is a sectional side view of the tool holder across line 4-4 in FIG. 3;

FIG. 5 is a sectional side view of the tool holder across line 5-5 in FIG. 4;

FIG. 6 is a partial enlarged view of FIG. 4;

FIG. 6A is a partial enlarged view of FIG. 6;

FIG. 7 is an operational view of the tool holder in FIG. 1; and

FIG. 8 is a sectional side view of a second preferred embodiment of a tool holder with enhanced cooling effect in accordance with the present invention.

### DETAILED DESCRIPTION OF THE PREFERRED EMBODIMENT

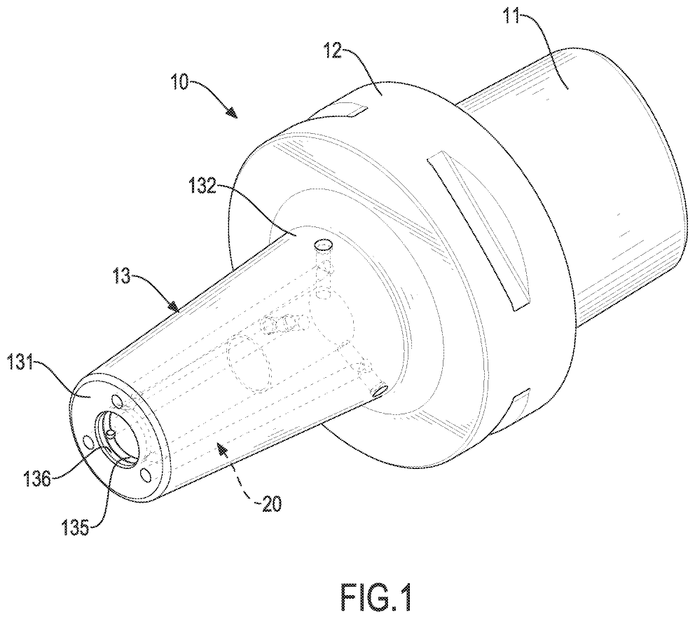

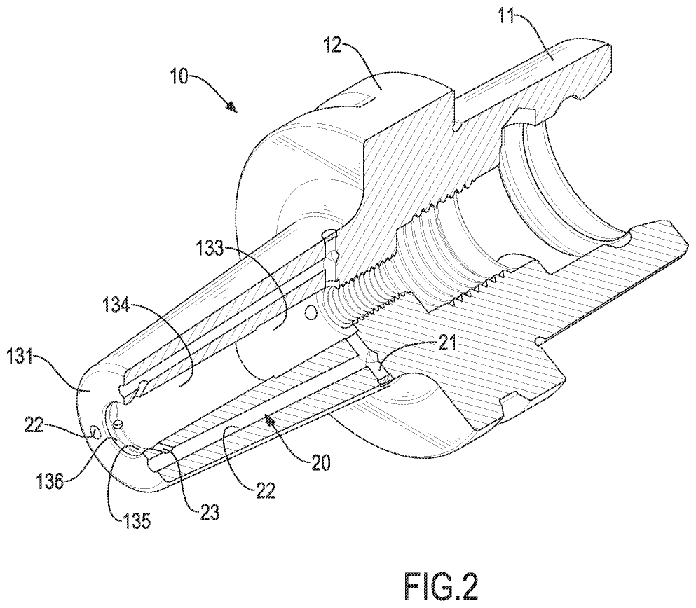

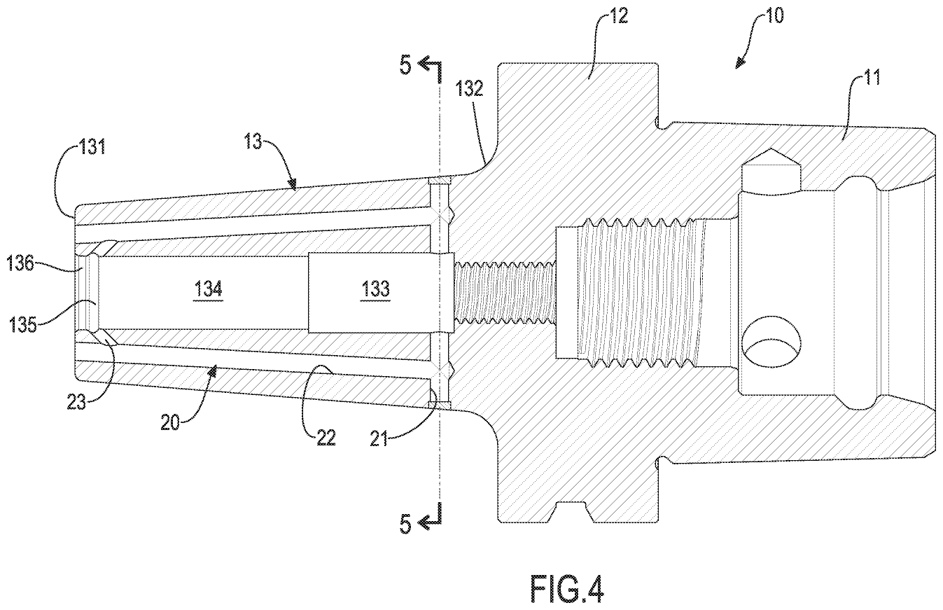

The present invention provides a tool holder with enhanced cooling effect. With reference to FIGS. 1 to 4, a first preferred embodiment of the tool holder has a body 10 and multiple flow passage systems 20, wherein the body has a handle portion 11, a flange portion 12, and a tool connecting portion 13 sequentially connected to each other and has a main construction substantially the same as that of the conventional tool holder. The tool connecting portion 13 has two opposite ends respectively being a front end 131 and a rear end 132, and the rear end 132 is connected to the flange portion 12. With reference to FIGS. 2 and 4, the tool connecting portion 13 has a coolant entering groove 133, a connecting groove 134, an annular ditch 135, and an annular inclined surface 136 all disposed inside the tool connecting portion 13. The connecting groove 134 is coaxially formed at a center of the tool connecting portion 13, communicates with the coolant entering groove 133, and has an opening located near the front end. The annular ditch 135 is formed on an inside wall of the connecting groove 134 and near the opening of the connecting groove 134, and the annular inclined surface 136 is connected to a side of the annular ditch 135 facing the opening.

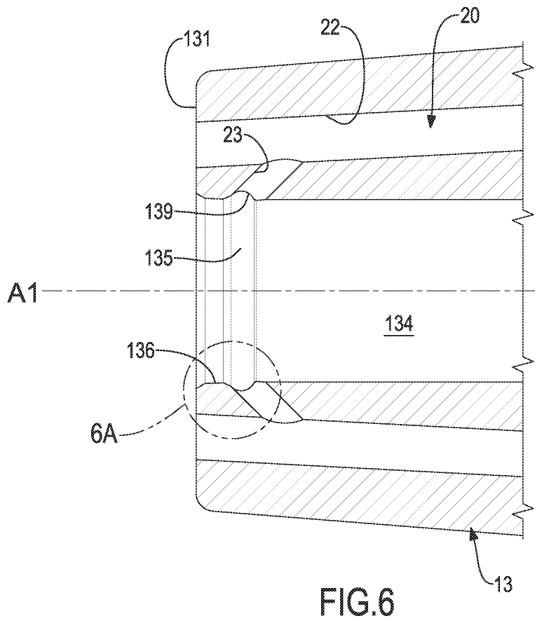

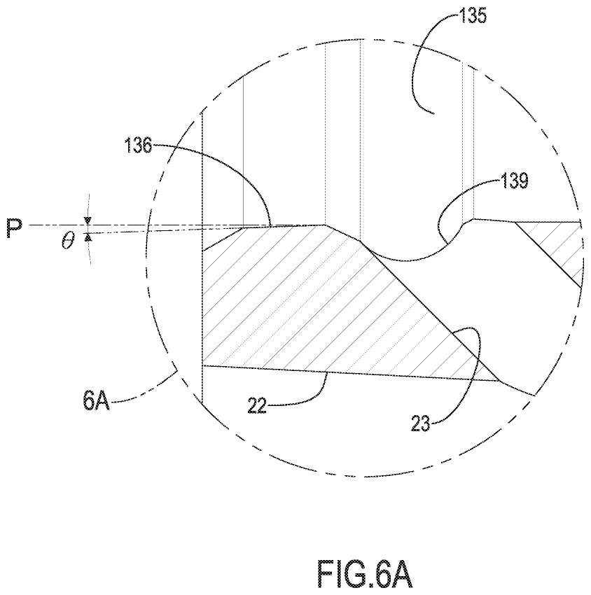

Further, with reference to FIGS. 6 and 6A, the body 10 has an included angle θ defined between the annular inclined surface 136 and an axis A1 of the body 10 (for better understanding, the included angle θ is marked between the annular inclined surface 136 and a parallel line P of the axis A1) such that the annular inclined surface 136 tapers away from the opening of the connecting groove 134; the coolant entering groove 133, the connecting groove 134, the annular ditch 135, and the annular inclined surface 136 are all coaxial with the axis A1 of the body 10.

With reference to FIGS. 2 to 5, the multiple flow passage systems 20 are formed on the body 10 at spaced intervals, and each one of the multiple flow passage systems 20 has an inlet passage 21, a main passage 22, and a branch passage 23. The inlet passage 21 is disposed on the tool connecting portion 13 and communicates with the coolant entering groove 133, and the main passage 22 extends from the inlet passage 21 and through the front end 131 of the tool connecting portion 13. The branch passage 23 extends obliquely from the main passage 22 to the annular ditch 135 of the tool connecting portion 13 and communicates with the annular ditch 135.

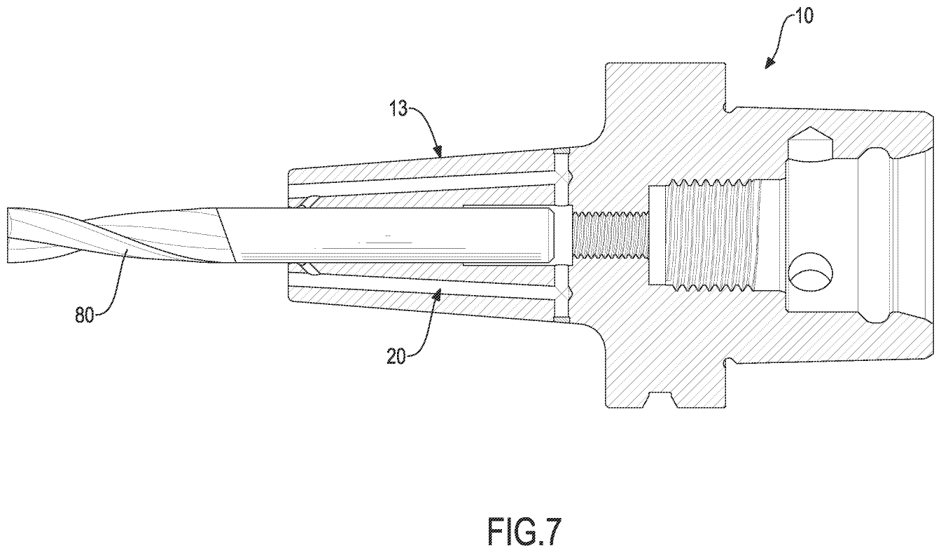

With reference to FIGS. 6 and 7, with the above-mentioned configurations, coolant can flow from the coolant entering groove 133, flow through the inlet passage 21 and the main passage 22 of each one of the multiple flow passage systems 20, and be ejected toward a tool 80 mounted on the tool connecting portion 13 for cooling and lubricating a cutting portion of the tool 80; a part of coolant flows to the annular ditch 135 when flowing through the branch passage 23 corresponding to said main passage 22 and then flows out of the body 10 by the divergent construction of the annular inclined surface 136, which maintains flow of coolant to effectively cool the tool 80. Therefore, the present invention enhances effect of cooling the tool mounted on the tool holder by configurations of the flow passages, which effectively resolves the problem of the conventional tool holder with coolant outlets having insufficient cooling effect.

Moreover, with reference to FIGS. 6 and 6A, the included angle θ between the annular inclined surface 136 and the axis A1 is between 1 and 5 degrees, endpoints inclusive; by the above range of the included angle θ, coolant flowing along the annular inclined surface 136 and the annular ditch 135 is controlled at better flow rate and flow velocity. In the first preferred embodiment, the included angle θ is 2 degrees. Furthermore, with reference to FIG. 6, the annular ditch 135 has a bottom surface 139, and the bottom surface 139 forms an inner rounded corner, which allows coolant to fluently flow around the tool 80 in the annular ditch 135 after flowing to the annular ditch 135 from said branch passages of the multiple flow passage systems 20. Afterwards, coolant flows out of the body 10 along the annular inclined surface 136 and forms an annular water screen to better wash away metal swarfs on a surface of the tool 80 generated during processing, which synchronously cools and cleans the tool 80.

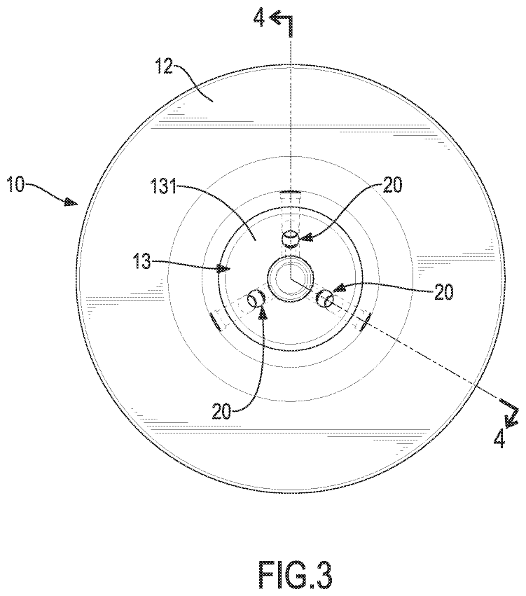

With reference to FIGS. 3, 5, and 6, the multiple flow passage systems 20 are disposed at equal angular intervals on the tool connecting portion 13 around the axis A1 of the body 10; e.g. when the tool holder has three flow passage systems 20, adjacent two of the multiple flow passage systems 20 form an angle being 120 degrees therebetween, such that said flow passage systems 20 equally cool the tool connecting portion 13 and the tool 80.

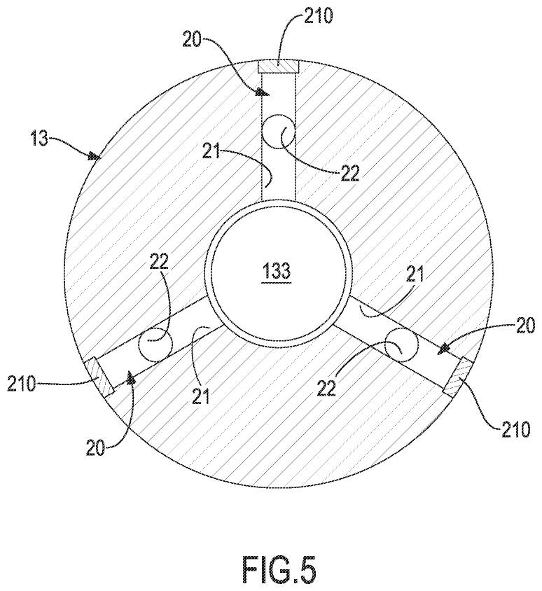

With reference to FIG. 5, the inlet passage 21 of each one of the multiple flow passage systems 20 is drilled inward and radially on the tool connecting portion 13 near the rear end 132 to communicate with the coolant entering groove 133, and a sealing element 21 seals an outside opening of the inlet passage 21. With reference to FIGS. 4 and 6, the main passage 22 of each one of the multiple flow passage systems 20 is drilled obliquely relative to the Axis A1 from the front end 131 of the tool connecting portion 13 to communicate with the corresponding inlet passage 21; with reference to FIG. 6, the branch passage 23 of each one of the multiple flow passage systems 20 is drilled obliquely from the opening of the connecting groove 134 toward a side wall of the connecting groove 134 to communicate with the corresponding main passage 22 and make the branch passage 23 of said flow passage system 20 extend toward the opening of the connecting groove 134 from the main passage 22. The above-mentioned configurations reduce cost of manufacture of the present invention, which is beneficial for industrial application.

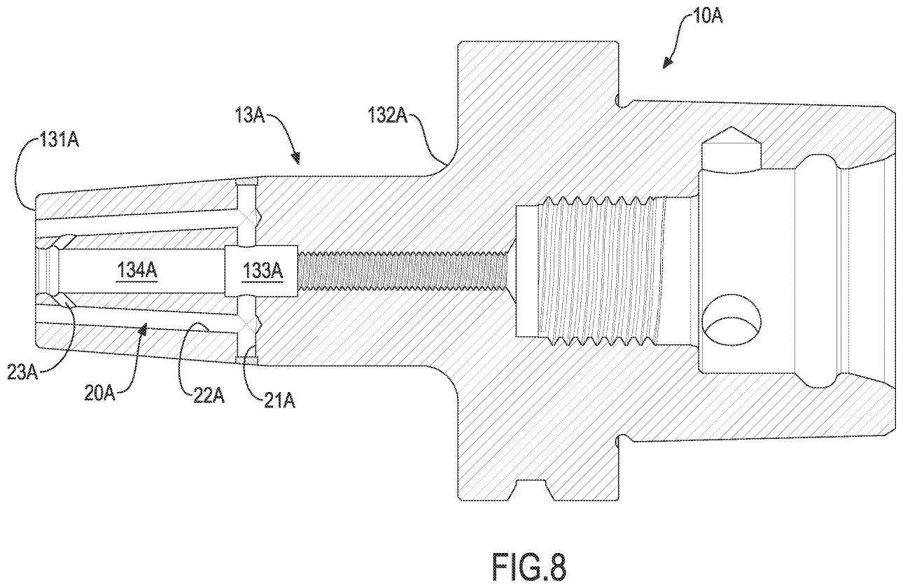

With reference to FIG. 8, the tool connecting portion 13A of the body 10 in a second preferred embodiment of the tool holder of the present invention is basically the same as the tool connecting portion 13 in the first embodiment. A difference between the first and the second preferred embodiments is that sizes of the coolant entering groove 133A and the connecting groove 134A are smaller than sizes of the coolant entering groove 133 and the connecting groove 134 in the first preferred embodiment to match tools in different sizes.

Since the connecting groove 134A is narrower and shorter, the coolant entering groove 133A is disposed away from the rear end 132A of the tool connecting portion 13A and at a middle between the front end 131A and the rear end 132A. Accordingly, the inlet passage 21A of each one of the multiple flow passage systems 20 is disposed at the middle between the front end 131A and the rear end 132A to communicate with the coolant entering groove 133A, and a length of the corresponding main passage 22A is also shortened; the corresponding branch passage 23A is disposed at a position approximately the same as the position of said branch passage 23 in the first preferred embodiment. In other words, the configurations of the present invention are applicable for different kinds of tool holders to enhance effect of cooling the tool mounted on the tool holder.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A tool holder, comprising:
a body having
a tool connecting portion having
two opposite ends respectively being a front end and a rear end;
a coolant entering groove;
a connecting groove coaxially formed at a center of the tool connecting portion and having an opening near the front end;
an annular ditch formed on an inside wall of the connecting groove and near the opening; and
an annular inclined surface connected to a side of the annular ditch which faces the opening; and
an included angle defined between the annular inclined surface and an axis of the body such that the annular inclined surface tapers away from the opening; and
multiple flow passage systems formed on the body at spaced intervals, and each one of the multiple flow passage systems having
an inlet passage disposed on the tool connecting portion and communicating with the coolant entering groove;
a main passage extending from the inlet passage and through the front end of the tool connecting portion; and
a branch passage extending obliquely from the main passage to the annular ditch and communicating with the annular ditch.

2. The tool holder as claimed in claim 1, wherein the included angle between the annular inclined surface and the axis of the body is between 1 and 5 degrees, endpoints inclusive.

3. The tool holder as claimed in claim 2, wherein the included angle between the annular inclined surface and the axis of the body is 2 degrees.

4. The tool holder as claimed in claim 1, wherein the annular ditch has a bottom surface forming an inner rounded corner.

5. The tool holder as claimed in claim 1, wherein the branch passage of each one of the multiple flow passage systems extends toward the opening of the connecting groove from the main passage.

6. The tool holder as claimed in claim 1, wherein the multiple flow passage systems are disposed at equal angular intervals on the tool connecting portion around the axis of the body.

7. The tool holder as claimed in claim 2, wherein the multiple flow passage systems are disposed at equal angular intervals on the tool connecting portion around the axis of the body.

8. The tool holder as claimed in claim 3, wherein the multiple flow passage systems are disposed at equal angular intervals on the tool connecting portion around the axis of the body.

9. The tool holder as claimed in claim 4, wherein the multiple flow passage systems are disposed at equal angular intervals on the tool connecting portion around the axis of the body.

10. The tool holder as claimed in claim 5, wherein the multiple flow passage systems are disposed at equal angular intervals on the tool connecting portion around the axis of the body.
